(19) United States
(12) Patent Application Publication
(10) Pub. No.: US 2007/0271179 A1
(43) Pub. Date: Nov. 22, 2007

(54) Payment Processing Support Device and Method

(76) Inventor: Kazushige Kubota, Tokyo (JP)

Correspondence Address: BAKER BOTTS L.L.P., 30 ROCKEFELLER PLAZA, 44TH FLOOR, NEW YORK, NY, 10112-4498, US

(21) Appl. No.: 11/734,653

(22) Filed: Apr. 12, 2007

(30) Foreign Application Priority Data
Apr. 12, 2006 (JP) 2006-110272

(51) Int. Cl. G06Q 40/00

(52) U.S. Cl. 705/39; 235/379

(57) ABSTRACT

Processing a signature debit card transaction as a credit card transaction when the debit card account contains insufficient funds to perform the transaction. The invention may include receiving transaction information comprising a transaction amount and signature debit card identification information from a point of sale terminal in a primary message format, generating a message in a secondary message format from the data contained in the primary message, transmitting the message in a secondary message format to a debit processing system that maintains an account associated with the signature debit card, receiving a response message from said debit processing system indicating whether the transaction amount is allowed based on the account balance of the account associated with the signature debit card and performing credit settlement of the signature debit card transaction when the response message indicates that said transaction amount is not allowed.

### RELATED APPLICATION

This application claims priority to Japanese Patent application 2006-110272, filed Apr. 12, 2006.

### TECHNICAL FIELD OF THE INVENTION

The present invention relates generally to the field of payment card transactions and, in particular, to payment processing support devices and payment processing support methods for debit and credit settlement.

### BACKGROUND OF THE INVENTION

In credit card systems, when a card member (card holder) uses a credit card to make purchases at an affiliated store at which the credit card may be used, the issuer of the credit card immediately covers payment of the transaction amount to the affiliated store. Thereafter, the credit card company bills the card member for the transaction amount, and the card member pays the credit card company, either all at once, or in installments.

Credit card information may comprise credit card issuer identification number, an individual card member account number, check digits, and optionally an expiration date and other identifying and security information, and the information may be embossed, printed, and/or magnetically recorded on a credit card, and recorded in a primary standard, for example, JIS I, ISO Primary Account Number (PAN) number system. The credit card is processed by transmitting the credit card information through a communications network such as Banknet™, Credit and Finance Information System™, GPnet™, or JCN to the backend.

FIG. 8A is a schematic diagram of a conventional credit card system. As shown in FIG. 8A, when credit card 110 is used at a credit card affiliated store, credit card information may be read from a magnetic stripe on the credit card by POS terminal 111 of the credit card affiliated store. Alternatively, the information may be read by wireless communications device, or from a contact pad on the card, or the information may be manually keyed in by an operator at the point of sale. Subsequently, a credit authorization inquiry may be made to backend system 112 for credit card 110 via communications network 113. If the proposed transaction is authorized, the product purchase or other transaction is carried out. Subsequently, such as at the end of the day, a sales finalization is transmitted to credit card network 113 for clearing and settlement of funds. Accordingly, credit card transactions are typically said to consist of two messages from the point of sale: an authorization request and a settlement/clearing, or finalization, message.

In a debit card system, on the other hand, when a debit card is used for payment at an affiliated store at which the debit card may be used, payment of the transaction amount is completed immediately by withdrawal from a deposit account at a financial institution, such as a savings or checking account. Debit cards differ from credit cards in that settlement is immediate. Because of this, creditworthiness and other factors are sometimes not audited when a debit card is issued. Debit cards are readily used by consumers who prefer not to incur debts, or for whom obtaining credit is relatively difficult.

Among such debit cards, there are Personal Identification Number (PIN) debit cards, with which a PIN is used for identity verification, and signature debit cards, with which a signature is used. In the case of PIN debit cards, the PIN that a card member inputs at a POS terminal in an affiliated store is traditionally sent online to the accounting system of a financial institution that issued the debit card. This system verifies the card member's identity by comparing the PIN that is registered in the system to the PIN that has been sent. For example, an automated teller machine (ATM) cash card that is issued by a financial institution is a type of PIN debit card, although in some areas, it can only be used at an ATM rather than at a merchant to make a purchase of goods or services.

Debit card information may comprise financial institution code, branch name, and account number and may be embossed, printed, and/or magnetically recorded on the debit card in a secondary standard (for example, the JIS II bank deposit account number standard) number system. The debit card account may be managed by a communications network, such as Multi Integrated Cash Service™, BANks Cash Service™, and All Japan Card Service™.

FIG. 8B is a schematic diagram of a conventional PIN debit card system. As shown in FIG. 8B, when PIN debit card 120 is used at a debit card affiliated store, debit card information is read from a magnetic stripe on the debit card by a POS terminal 121 of the debit card 120 affiliated store, by a smart card contact pad reader, by a contactless card reader, or by other interface as will be apparent to one of ordinary skill in the art. Additionally, a PIN number is input by the card member. This PIN number and the debit card information read from the card are then used together to access financial institution accounting system 122, via communications network 123. If the PIN input by the card member matches the PIN stored for the card member by the financial institution accounting system 122 as described above, settlement processing of the transaction amount against the deposit account of the card member is carried out immediately.

In contrast, identity verification in the case of signature debit cards is carried out at the affiliated store by visual comparison of a signature written on a card voucher of the affiliated store with a signature that is written on the reverse side of the debit card. Subsequently, settlement processing of the deposit account is carried out either online or offline. Thus, the method of using a signature debit card is similar to the method of using a credit card in that identity verification at the time of use is by visual comparison. For this reason, many signature debit cards are issued by credit card companies, rather than financial institutions, and they are managed using credit card communications equipment and associated software. The information for the signature debit card is therefore formatted according to the same standard as for a credit card, referred to herein occasionally as a primary standard, for example, the primary standard may be JIS I, ISO Primary Account Number (PAN) number system.

FIG. 9 is a schematic diagram of a signature debit card system. As shown in FIG. 9, converter 131, which converts messages from a primary standard, such as a credit card or debit signature card message to secondary standard, such as a PIN debit message, is arranged between credit card 110 communications network 113 and financial institution accounting system 122, for processing signature debit card 130. When signature debit card 130 is used at POS terminal 111 at a credit card affiliated store, credit card POS terminal 111 sends the primary standard (JIS I, ISO standard) credit inquiry message, which it has read from signature debit card 130, to converter 131. Converter 131 converts the primary credit inquiry (or authorization request) message that it has received to a secondary standard (such as, for example, JIS II) credit inquiry or authorization request message, and carries out settlement processing by accessing financial institution accounting system 122. At this time, converter 131 is connected to financial institution accounting system 122, which verifies identity by PIN. Therefore, when signature debit card 130 is used, converter 131 appends a flag to the secondary standard secondary credit inquiry message that invalidates the PIN inquiry, and the secondary standard secondary credit inquiry message is sent to accounting system 122 for processing. The response to the credit inquiry in secondary standard format from accounting system 122 is then sent to converter 131, is converted to primary standard by converter 131, and is sent in primary standard format to POS terminal 111. Settlement processing of the deposit account is carried out either at the time of credit inquiry processing, or at the time of sales finalization processing after credit inquiry.

If PIN debit card 120 and signature debit card 130 are compared, PIN debit card 120 verifies identity with greater precision, using a PIN for identity verification. However, to verify a transaction using a PIN debit card 120, it is necessary to send the PIN online to a financial institution accounting system, creating new needs for encryption processing and a large-scale communications network that is configured for a new message format. Since, with signature debit card 130, as with credit card 110, identity is verified based on signature, existing credit card 110 communications network facility 113 can be used, and in this sense, signature debit card 130 is more advantageous than PIN debit card 120.

Although signature debit card 130 has the aforementioned advantage, use thereof has not become widespread in certain areas, such as Japan, as will now be explained below.

In a credit card 110 system, as shown in FIG. 8A, if a card member presents credit card 110 at an affiliated store when purchasing products, the affiliated store typically makes a credit inquiry by sending a credit inquiry message, such as an authorization request, to credit card 110 backend system 112, via POS terminal 111. After this credit inquiry, if the transaction is authorized and completed, transaction processing is performed by sending a sales finalization, settlement, or clearing message to credit card 110 backend system 112, via POS terminal 111.

However, credit inquiry and settlement may be carried out in other ways that may result in overuse (i.e., exceeding a credit or debit limit) of the account. For example, when the transaction amount is less than a predetermined amount (typically referred to as a “floor limit”), credit inquiry messages may not be sent to credit card 110 backend system 112 before the transaction is permitted. Further, since credit inquiries are sometimes made offline (for example, in Japan, offline processing accounts for approximately 10-20% of all credit card transactions), credit limits may be exceeded resulting in overuse.

For example, if delays and omission of credit inquiries occur as a result of conducting credit inquiries offline, the credit card company will be unable to make credit inquiries at transaction time about card members who are using credit card 110, and as a result, the credit limit for credit card 110 may be exceeded. For example, if a card member with a credit limit of 3,000 dollars who has already used 2,950 dollars makes a purchase for 90 dollars, the credit limit will be exceeded by 40 dollars. In this way, the card member may overuse (i.e., exceed a credit or debit limit) the card unintentionally.

Similar to existing credit card 110, it is necessary to process credit inquiries and sales finalizations for signature debit card 130. Problems of overuse similar to those encountered with credit card 110 arise when credit inquiries are omitted, or are not carried out in online or in real time, for signature debit card 130. That is, if signature debit card 130 is used, credit inquiries may be conducted offline. If only sales finalization processing is carried out, without authorization or identity inquiries, settlement processing of a relevant deposit account is not carried out immediately at transaction time, and may be carried out several days to several months later. In such cases, overuse will occur if the amount that a card member has left in the relevant deposit account at a financial institution is less than the transaction amount. The overuse amount will typically be borne either by the affiliated store or the financial institution. Thus, this is the reason that signature debit cards are not widely used in countries such as Japan.

Accordingly, there is a need for a method and system for reducing and/or eliminating the aforementioned risks associated with overuse for signature debit cards 130.

### SUMMARY OF THE INVENTION

One object of certain embodiments of the present invention is to reduce or eliminate a financial institution's costs resulting from overuse occurring when signature debit cards are used.

An object of certain embodiments of the present invention is to limit risk of overuse conventionally borne by credit card companies.

An additional object of certain embodiments of the present invention is to provide a payment processing support device and payment processing support method that make it possible to disseminate use of signature debit cards.

In one exemplary embodiment of the invention, a payment processing support device is connected via a network to a credit card point of sale (POS) terminal and a credit card backend system that is connected to the POS terminal via a network. The payment processing support device is additionally connected to an accounting system of a financial institution at which a deposit account has been opened. Debit settlement processing is enabled by the financial institution accounting system if a debit card is used at a credit card POS terminal.

In this exemplary embodiment, the debit card is a signature debit card that complies with a primary standard of the credit card system, whereby identity of the card user is verified by comparing the signature written on a card voucher with a signature written on the card. Payment processing support device of this exemplary embodiment may include communication means that communicates via a network with the POS terminal, the credit card backend system, and the financial institution accounting system. The payment processing support device additionally comprises conversion means that converts a primary credit inquiry message, or transaction information message, which has been sent from the POS terminal, and which includes the transaction amount in compliance with the primary standard of the credit card system, into a secondary credit inquiry message that complies with a secondary standard of the financial institution, such as a PIN debit message type.

If the debit card is used at the credit card POS terminal, and a primary credit inquiry message complying with the primary standard of the credit card system is received, the conversion means converts the primary credit inquiry message that has been received by the communication means to a secondary credit inquiry message that complies with the secondary standard, and the communication means sends the secondary credit inquiry message to the financial institution accounting system, so that debit settlement processing can be carried out by the financial institution accounting system.

If the communication means receives a settlement rejection reply message from the financial institution accounting system, the communication means sends the primary credit inquiry message to the credit card backend system, so that credit settlement processing may be carried out by the credit card backend system.

An another exemplary embodiment, the payment processing support device may comprise differentiating means that differentiates the primary credit inquiry message. That is, if the differentiating means recognizes the primary credit inquiry message as a primary credit inquiry message, having the objective of validating a credit card, or as a special message that is a primary credit inquiry message having the objective of reserving in advance a transaction amount, the communication means sends the primary credit inquiry message to the credit card backend system without converting it to the secondary credit inquiry message so that credit settlement processing may be carried out by the credit card backend system.

In another exemplary embodiment of the invention. the payment processing support device may comprise log storage, which may be for example a hard drive, file server, or other storage medium containing a database or data files, such that if the communication means has received a primary credit inquiry message from the credit card POS terminal, stores a log of the primary credit inquiry message.

In another exemplary embodiment, the payment processing support device may comprise a comparator that, if the communication means has received from the credit card POS terminal a sales finalization, settlement, or clearing message complying with the primary standard, the comparator compares the sales finalization message to the log of the primary credit inquiry message that is stored in the log storage. If the comparing means determines that a primary credit inquiry message corresponding to the sales finalization message does not exist in the log storage means, the conversion means generates a secondary credit inquiry message, based on the sales finalization message received by the communication means. The communication means sends the secondary credit inquiry message, generated on the basis of the sales finalization message, to the financial institution accounting system, so that debit settlement processing can be carried out by the financial institution accounting system. If the communication means receives a settlement rejection reply message from the financial institution accounting system in response to the secondary credit inquiry message, the sales finalization message is sent to the credit card backend system, so that credit settlement processing can be carried out by the credit card backend system.

If the comparing means determines that the transaction amount included in a sales finalization message that is received by the communication means is greater than the transaction amount in the primary credit inquiry message log, the conversion means generates a secondary credit inquiry message log, based on an additional amount, which is the difference between the transaction amount in the primary credit inquiry message log and the transaction amount in the sales finalization message received by the communication means. The communication means sends the secondary credit inquiry message, with the additional amount, to the financial institution accounting system, so that debit settlement processing may be carried out by the financial institution accounting system.

If the communication means receives a settlement rejection reply message from the financial institution accounting system in response to the secondary credit inquiry message, the sales finalization message is sent to the credit card backend system, so that credit settlement processing can be carried out by the credit card backend system. The conversion means generates a secondary standard message canceling debit settlement processing carried out based on the secondary credit inquiry message. The communication means sends the cancellation message to the financial institution accounting system so that settlement processing can be cancelled by the financial institution accounting system.

If the communication means receives a settlement rejection reply message from the financial institution accounting system in response to the secondary credit inquiry message, the conversion means generates a sales finalization message, based on an additional amount, which is the difference between the transaction amount in the primary credit inquiry message log and the transaction amount in the sales finalization message received by the communication means. The communication means sends the sales finalization message, with the additional amount, to the credit card backend system, so that credit settlement processing may be carried out by the credit card backend system.

If the transaction amount included in a sales finalization message that is received by the communication means is determined by the comparing means to be less than the transaction amount in the primary credit inquiry message log, the conversion means generates a cancellation notice that includes a refund amount. The refund amount is the difference between the transaction amount in the primary credit inquiry message log and the transaction amount in the sales finalization message received by the communication means. The communication means sends the cancellation message, with the refund amount, to the financial institution accounting system, so that debit settlement processing may be carried out by the financial institution accounting system.

In another exemplary embodiment of the present invention, the payment processing support device may also comprise a timer means, such as a clock, that measures the time from receipt of the primary credit inquiry message by the communication means. If the communication means determines, with reference to the timer means, that a predetermined time has passed since receipt of the primary credit inquiry message without receipt of a sales finalization message from the credit card POS terminal, the conversion means generates a secondary standard message canceling debit settlement processing carried out based on the secondary credit inquiry message. The communication means sends this cancellation message to the financial institution accounting system so that settlement processing may be cancelled or reversed by the financial institution accounting system.

If the conversion means converts the primary credit inquiry message to the secondary credit inquiry message, a flag that invalidates authentication processing is appended to the secondary credit inquiry message.

The payment processing support method of the present invention is carried out using the aforesaid payment processing support device. This method may be achieved using a payment support device, which may be a computer program stored on a computer. This computer program can be distributed by network, or stored on recording media such as optical disks, which recording media may then be distributed through conventional sales channels.

Thus, in one exemplary embodiment, if a signature debit card is used at a credit card POS terminal, a primary credit inquiry message, complying with primary credit card standards, is transmitted. The primary credit inquiry message is converted to a secondary credit inquiry message complying with secondary credit card standards of a financial institution. The secondary credit inquiry message is sent to the financial institution accounting system so that debit settlement processing may be carried out by the financial institution accounting system. When a settlement rejection reply message from the financial institution accounting system is received, the communication means sends the primary credit inquiry message to the credit card backend system so that credit settlement processing may be carried out by the credit card backend system. That is, debit settlement is usually carried out and, in exceptional cases, credit settlement is carried out.

Certain embodiments of the invention may provide numerous technical advantages. For example, a technical advantage of one embodiment may include eliminating the risk borne by financial institutions of overuse occurring when signature debit cards are used. An additional technical advantage of this embodiment and/or of an alternate embodiment may include limiting the risk of overuse to the range conventionally borne by credit card companies.

The accompanying drawings, which are incorporated and constitute part of this disclosure, illustrate preferred embodiments of the invention and serve to explain the principles of the invention.

### BRIEF DESCRIPTION OF THE DRAWINGS

For a more complete understanding of example embodiments of the present invention and its advantages, reference is now made to the following description, taken in conjunction with the accompanying drawings, in which:

FIG. 1 is a schematic diagram of a credit and debit card system with a payment processing support device according to the present invention;

FIG. 2 is a schematic diagram of the payment processing support device according to the present invention;

FIG. 3 is a flowchart of the operation of the payment processing support device according to the present invention;

FIG. 4 is a continuation of the flowchart of FIG. 3 of the operation of the payment processing support device when there is no primary credit inquiry message log entry for a signature debit card transaction;

FIG. 5A is a continuation of the flowchart of FIG. 4 of the operation of the payment processing support device when a transaction amount included in a sales finalization message is greater than a transaction amount included in a primary credit inquiry message log corresponding to the sales finalization message;

FIG. 5B is a flowchart of an alternate embodiment of FIG. 5A of the operation of the payment processing support device when the transaction amount included in the sales finalization message is greater than the transaction amount included in the primary credit inquiry message log corresponding to the sales finalization message;

FIG. 6 is a continuation of the flow chart of FIG. 5A of the operation of the payment processing support device when the transaction amount included in the sales finalization message is less than the transaction amount included in the primary credit inquiry message log corresponding to the sales finalization message;

FIG. 7 is a schematic diagram of an alternate embodiment of the credit and debit card system and the payment processing support device according to the present invention;

FIG. 8A is a schematic diagram of a conventional credit card system;

FIG. 8B is a schematic diagram of a conventional PIN debit card system; and

FIG. 9 is a schematic diagram of a signature debit card system.

Throughout the drawings, the same reference numerals and characters, unless otherwise stated, are used to denote like features, elements, components or portions of the illustrated embodiments. Moreover, while the present invention will now be described in detail with reference to the Figures, it is done so in connection with the illustrative embodiments.

### DETAILED DESCRIPTION

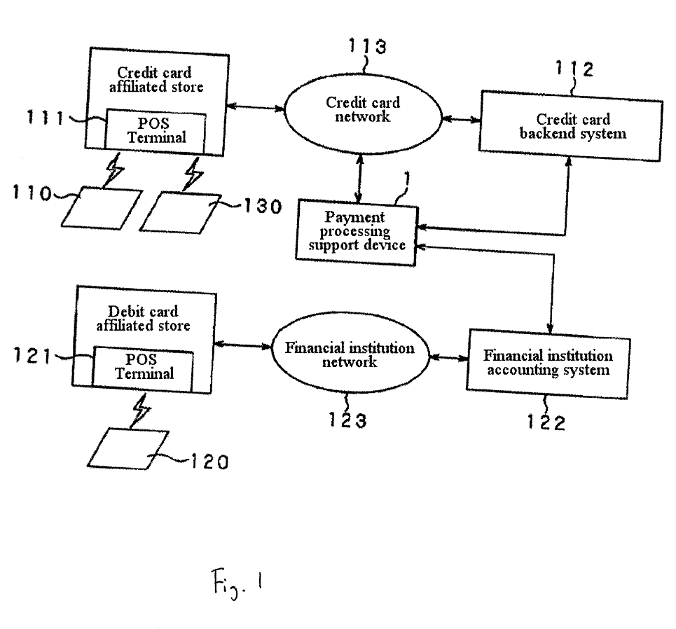

FIG. 1 is a schematic diagram of a credit and debit card system with a payment processing support device according to the present invention. As shown in FIG. 1, payment processing support device 1, in which the present invention is applied, is a device wherein credit card 110 POS terminal 111, which is installed in a credit card affiliated store, and credit card 110 backend system 112 are mutually connected by credit card 110 communications network 113. In addition, PIN debit card POS terminal 121, which is installed in an ATM or debit card affiliated store, and financial institution accounting system 122, are mutually connected via financial institution communications network 123. Messages communicated between these two communications networks 113 and 123 are converted by payment processing support device 1, enabling credit card 110 backend system 112 to access financial institution accounting system 122.

A credit card 110 card member may use credit card 110 at a credit card affiliated store. Credit card 110 may have credit card information comprising credit card 110 issuer identification number, an individual card member account number, check digits, and an expiration date embossed, printed, and/or magnetically recorded on credit card 110, and recorded in a primary standard (JIS I, ISO Primary Account Number (PAN)) number system. The reverse side of credit card 110 is signed for the purpose of identity verification. When credit card 110 is used, the signature on the reverse of the card is visually compared with the signature on the card voucher as described above. Although the terms “credit card” and “debit card” include traditional plastic card-shaped tokens used to perform credit or debit transactions at a point of sale, as used herein, the terms “credit card” and “debit card” are not limited to these traditional tokens, and should be understood to mean any physical token associated with a credit card or debit card account used to perform a transaction, including RF payment devices, magstripe cards, and smart cards, whether or not such devices are card-shaped.

As shown in FIG. 1, credit card information is read from a magnetic stripe by POS terminal 111 of the credit card affiliated store. An online credit inquiry is conducted when the credit inquiry is sent to backend system 112 for credit card 110 via communications network 113. Inquiries may also be conducted offline by such means as telephone, fax or postal mail. Thereafter, the affiliated store sends a sales finalization, settlement, or clearing message online to backend system 112, and sales finalization processing is carried out. Offline sales finalization processing may also be carried out.

In some cases, a large scale store, such as a department store, may carry out online or offline sales finalization processing for a credit card 110 transaction without making a credit authorization inquiry. One such case where the large scale store may carry out finalization processing without making a credit inquiry is when the transaction amount falls below a threshold known as the “floor limit.”

In addition, there are other cases in which a credit inquiry is made online for the purpose of checking credit card validity without carrying out purchase finalization. In this case, very small amounts such as 1 dollar are involved. This type of credit inquiry is referred to below as a “1-dollar authorization.”

Further, a hotel or the like may reserve a relatively large transaction amount range for room charges and the like by conducting an online credit inquiry. The hotel or the like may then carry out sales finalization processing of the actual transaction amount during sales finalization processing. This type of credit inquiry is referred to below as an “authorization reservation.”

A PIN debit card 120 card member may use PIN debit card 120 at an ATM and PIN debit card affiliated store. Debit card information may comprise financial institution code, branch name, and account number and may be embossed, printed, and/or magnetically recorded on PIN debit card 120 in a secondary standard (for example, JIS II bank deposit account number) number system.

As shown in FIG. 1, when PIN debit card 120 is used, the card member inputs the PIN number into the POS terminal 121 and debit card information is read from the PIN debit card 120 by POS terminal 121 of the debit card affiliated store. The PIN number and debit card information is then used together to access financial institution accounting system 122, via communications network 123. After PIN matching occurs, settlement processing of the deposit account of the card member is carried out immediately.

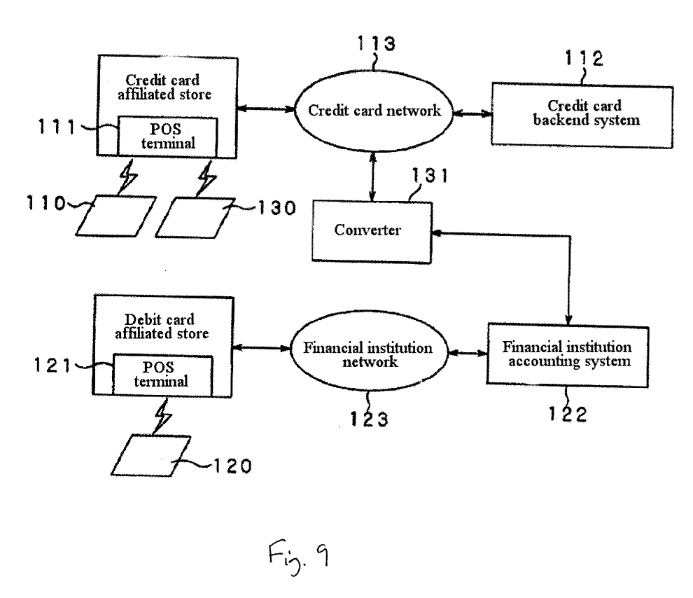

Regarding signature debit card 130, credit card information may comprise credit card 110 issuer identification number, an individual card member account number, check digits, and expiration date and may be embossed, printed, and/or magnetically recorded on signature debit card 130 in a primary standard (JIS I, ISO Primary Account Number (PAN)) number system. The signature of the card member holding the card is written on the reverse side. Payment processing support device 1 is a device that includes the functions of conventional converter 131 of FIG. 9. When signature debit card 130 is used at POS terminal 111 in a credit card affiliated store, the primary standard (JIS I, ISO standard) primary credit inquiry message read from signature debit card 130 is converted to a secondary standard (JIS II) secondary credit inquiry message. The secondary credit inquiry message is sent to the financial institution accounting system 122 for settlement processing. At this time, payment processing support device 1 verifies the card member's identity by PIN. When a debit card is used, a flag is appended that invalidates the PIN inquiry, and a secondary standard secondary credit inquiry message is sent to accounting system 122. The response to the credit inquiry is then sent in secondary standard from accounting system 122 to payment processing support device 1. Payment processing support device 1 converts the response to the secondary credit inquiry to primary standard, and sends the converted message to POS terminal 121. In one exemplary embodiment of the present invention, accounting system 122 may carry out settlement processing at the time of the credit inquiry. If the balance in the deposit account of the card member at the financial institution is less than the transaction amount, payment processing support device 1 carries out processing as if a credit card had been used.

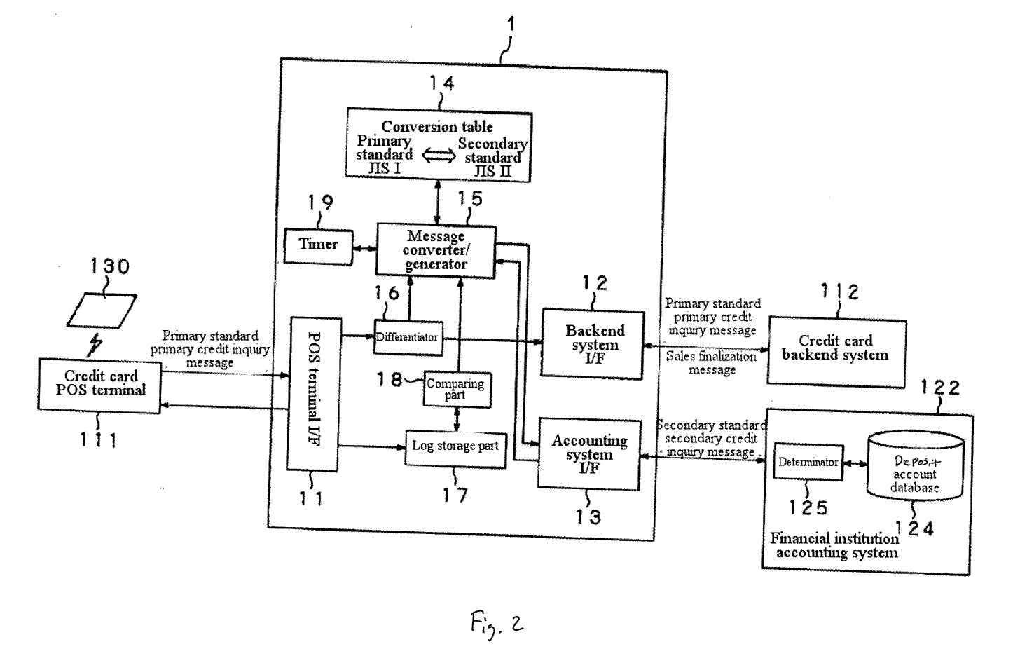

FIG. 2 is a schematic diagram of the payment processing support device according to the present invention. Payment processing support device 1, is a device having a configuration similar to that of an ordinary server, comprising a database, a hard disk on which programs and the like are stored, random access memory (RAM) wherein data is loaded, a central processing unit (CPU) that carries out computation, and the like. The functions described below are achieved by payment processing support device 1 through computer programs stored and executed on the server. Payment processing support device 1 may also achieve these functions through the use of hardware.

Payment processing support device 1 comprises POS terminal interface (hereinafter, “I/F”) 11, which communicates with credit card POS terminal 111. Payment processing support device 1 also comprises backend system I/F 12, which communicates with credit card backend system 112, and accounting system I/F 13, which communicates with financial institution accounting system 122.

POS terminal I/F 11 is an I/F that communicates with POS terminal 111 using messages that comply with the primary standard. Specifically, POS terminal I/F 11 receives primary credit inquiry messages that have been sent from POS terminal 111. For example, primary credit inquiry messages may be standard credit authorization request messages in ISO 8583 format as adopted to the particular credit card network being used, or may be in another credit card message format known to persons of ordinary skill. I/F 11 also sends to POS terminal 111, in the primary standard, the reply messages from credit card backend system 112. POS terminal I/F 11 also receives from POS terminal 111 sales finalization messages that comply with the primary standard, and sends to POS terminal 111, in primary standard compliance, the reply messages thereto. It will be understood by persons of ordinary skill in the art that the POS terminal I/F may not be connected directly to a point of sale device, but may instead be connected to a computer operated by a merchant's acquiring financial institution, or the merchant's processor.

Backend system I/F 12 is an I/F that communicates with credit card backend system 112 in messages that comply with the primary standard. Specifically, backend system I/F 12 sends primary standard credit inquiry messages to credit card backend system 112, and receives reply messages that comply with the primary standard. Backend system I/F 12 also sends to credit card backend system 112 sales finalization messages that comply with the primary standard, and receives reply messages that comply with the primary standard from credit card backend system 112. That is, POS terminal I/F 11 and backend system I/F 12 communicate with the credit card system, and communicate in messages that comply with the primary standard. Although credit card backend system 112 is shown as one box in FIG. 1, persons of skill in the art will recognize that the functionality of system 112 may be split into various hardware and/or software components.

Accounting system I/F 13 communicates with financial institution accounting system 122. Specifically, accounting system I/F 13 exchanges with accounting system 122 messages that comply with the secondary standard. I/F 13 sends to the accounting system 122 secondary credit inquiry messages that have been converted to secondary from primary standard primary credit inquiry messages. I/F 13 receives from the accounting system 122 a settlement permission or rejection reply message formatted according to the secondary standard.

In addition, the present payment processing support device 1 comprises conversion table 14 and message converter/generator 15. Converter/generator 15 generates secondary messages conforming to the secondary standard from primary messages conforming to the primary standard by referencing conversion table 14.

Conversion table 14 is a table showing the relationship between the primary standard number system and the secondary standard number system. That is, the primary standard (for example, JIS I, ISO Primary Account Number (PAN)) is a number system for credit card information items such as credit card 110 issuer identification number, individual card member account number, check digits, and expiration date. Secondary standard (for example, JIS II bank deposit account number) is a number system for debit card information such as financial institution code, branch name, and account number. Conversion table 14 shows the relationship between the primary standard number system and the secondary standard number system, enabling message converter/generator 15 to convert from primary standard to secondary standard, and vice versa, to generate messages.

As discussed above, converter/generator 15 may convert message with reference to conversion table 14. For example, if POS terminal I/F 11 receives a primary credit inquiry message, the primary standard primary credit inquiry message received may be converted to a secondary standard secondary credit inquiry message. Accounting system 122 supports PIN debit card 120. Therefore, a PIN is requested if a secondary credit inquiry message is received. However, there is no PIN for signature debit card 130. When converter/generator 15 generates a secondary credit inquiry message from a primary credit inquiry message, converter/generator 15 may append a flag that invalidates PIN requests from accounting system 122. As a result, payment processing support device 1 makes it possible to carry out debit settlement by sending secondary credit inquiry messages from accounting system I/F 13. When converter/generator 15 switches from settlement by debit card to settlement by credit card, a cancellation message, canceling debit settlement processing that has already been carried out, is generated.

Timer 19 is connected to converter/generator 15. Converter/generator 15 measures the time that passes after receipt of a primary credit inquiry message. If a sales finalization message has not been received by POS terminal I/F 11 even after a predetermined period of 30-40 days, for example, has passed, a cancellation message is issued, canceling debit settlement that had been carried out at the credit inquiry message receipt stage.

The payment processing support device 1 also comprises differentiator 16, which differentiates primary credit inquiry messages complying with the primary standard that are sent from credit card POS terminal 111. The payment processing support device 1 also comprises log storage part 17, which stores logs of primary credit inquiry messages that are received from credit card POS terminal 111. The payment processing support device 1 comprises comparing part 18 that compares primary credit inquiry message logs to sales finalization messages received from POS terminal 111.

Differentiator 16 differentiates by type primary credit inquiry messages sent from POS terminal 111 that have been received by POS terminal I/F 11. That is, differentiator 16 determines based on identifiers contained in the credit inquiry message whether the credit inquiry message that has been received is that of a credit card 110 or that of a signature debit card 130. Differentiator 16 also determines based on identifiers contained in the credit inquiry message whether the credit inquiry message that has been received is a 1-dollar authorization or authorization reservation. If differentiator 16 determines that the credit inquiry message is a 1-dollar authorization or authorization reservation, the 1-dollar authorization or authorization reservation credit inquiry message is sent in primary standard from backend system I/F 12 to backend system 112 without conversion to a secondary credit inquiry message by converter/generator 15.

When a primary credit inquiry message is received by POS terminal I/F 11, log storage part 17 stores the date and time received, transaction amount, issuer identification number, individual card member account number, expiration date, and other credit card information. The date and time received are converted to a standard date and time for debit settlement cancellation message generation. A settlement cancellation message is generated if the aforementioned sales finalization message has not been received after the predetermined term has passed. Log storage part 17 is also used when comparing the transaction amount to the transaction amount in the sales finalization message.

Comparing part 18 compares the primary credit inquiry message log stored in log storage part 17 with the sales finalization message received by POS terminal I/F 11 and determines whether the transaction amounts are equivalent. This step must be performed because if shipping charges, tips, taxes, and the like have been added to the price after the credit inquiry was carried out, the amount at the time of sales finalization may be greater than at the time of the credit inquiry. Alternatively, if a coupon was used after the credit inquiry was carried out, the amount at the time of sales finalization may be less than at the time of the credit inquiry. Therefore, if the transaction amount in the sales finalization message is greater than the amount in the primary credit inquiry message, a secondary credit inquiry message may be generated by converter/generator 15, enabling debit settlement of an additional amount, which is the difference by which the transaction amount in the primary credit inquiry message log is less than the transaction amount in the sales finalization message. If the transaction amount in the sales finalization message is less than the transaction amount in the primary credit inquiry message, a cancellation notice that includes the refund amount, which is the amount by which the transaction amount in the sales finalization message is less than the transaction amount in the primary credit inquiry message log, is generated by converter/generator 15.

As shown in FIG. 2, financial institution accounting system 122 comprises database 124 that manages deposit accounts of card members. Financial institution accounting system 122 also comprises determinator 125 that compares the transaction amount included in the secondary credit inquiry message sent from accounting system I/F 13 of payment processing support device 1 to the balance in the deposit account.

When a primary credit inquiry message is received from accounting system I/F 13, determinator 125 accesses database 124, and determines whether the deposit balance in the account in the name of the relevant account holder is less than the transaction amount. If the determinator determines that the transaction amount is less than the deposit balance, settlement processing is carried out, and a settlement completion reply message is sent to accounting system I/F 13. If the determinator 125 determines that the transaction amount is greater than the deposit balance, a settlement rejection reply message is sent to accounting system I/F 13, so that settlement will not occur.

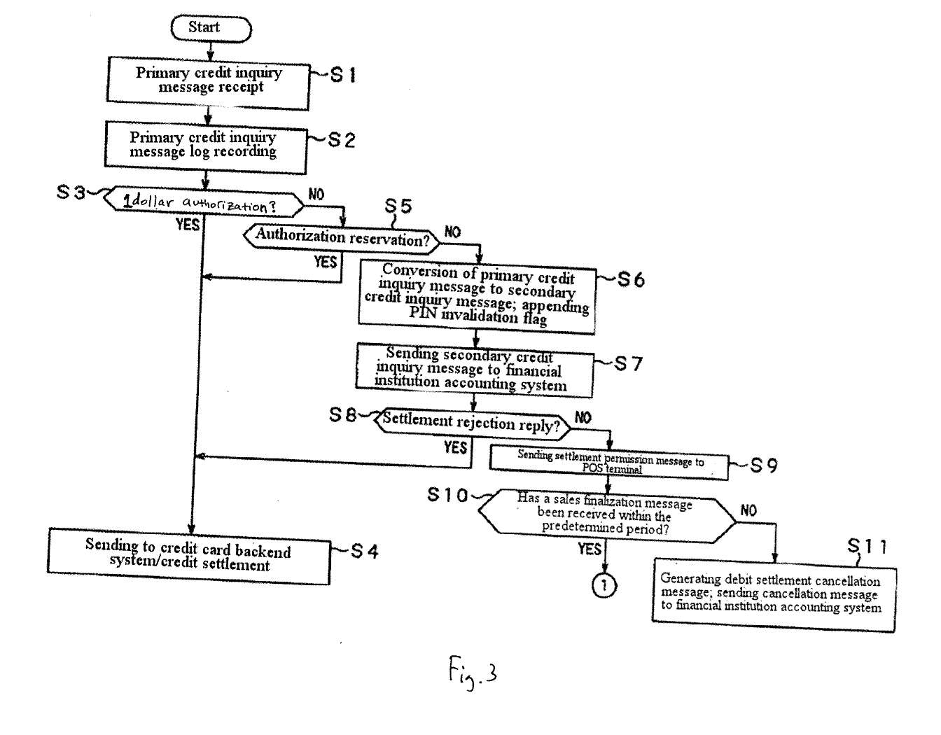

The following is a description of the operation of payment processing support device 1, in which the present invention is applied, as illustrated in FIGS. 3-6.

In step S1, as shown in FIG. 3, upon receiving in POS terminal I/F 11 a primary credit inquiry message sent from POS terminal 111, payment processing support device 1 determines, using differentiator 16, whether the primary credit inquiry message is a credit inquiry message concerning credit card 110, or a credit inquiry message concerning signature debit card 130, for example by examining the primary card number or other data included in the message. If the primary credit inquiry message is a credit inquiry message concerning credit card 110, the credit inquiry message is sent as it is to backend system 112 from backend system I/F 12. That is, ordinary processing for credit card 110 is carried out. If payment processing support device 1 determines, using differentiator 16, that the credit inquiry message concerns signature debit card 130, an entry is stored in log storage part 17 during step S2. Specifically, credit card information comprising date and time received, transaction amount, issuer identification number, individual card member account number, expiration date, and other credit card information are stored in log storage part 17.

In step S3, payment processing support device 1, using differentiator 16, determines, from identifiers contained in the primary credit inquiry message, whether the primary credit inquiry message is a 1-dollar authorization credit inquiry message. If the primary credit inquiry message is a 1-dollar authorization credit inquiry message, the process proceeds to step S4. In step S4, the 1-dollar authorization credit inquiry message is sent, without conversion, to credit card 110 backend system 112 from backend system I/F 12. That is, the ordinary processing for credit card 110 is carried out.

If differentiator 16 determines that the primary credit inquiry message that has been received is not a 1-dollar authorization credit inquiry message, differentiator 16 refers, in step S5, to the identifiers contained in the primary credit inquiry message that has been received to determine whether the primary credit inquiry message is an authorization reservation. If the primary credit inquiry message that has been received is an authorization reservation credit inquiry message, the process proceeds to step S4. In step S4, the authorization reservation credit inquiry message is sent, without conversion, to credit card 110 backend system 112 from backend system I/F 12, as with the 1-dollar authorization. That is, ordinary processing for credit card 110 is carried out.

If differentiator 16 determines that the primary credit inquiry message that has been received is not an authorization reservation, payment processing support device 1 uses message converter/generator 15 to carry out processing in step S6, whereby the primary credit inquiry message for signature debit card 130 is converted to a secondary credit inquiry message. That is, message converter/generator 15 converts the primary credit inquiry message, which is in compliance with the primary standard that is implemented in relation to credit card 110, to a secondary credit inquiry message, which is implemented in compliance with the secondary standard of financial institution systems for a debit transaction. At this time, message converter/generator 15 appends a flag to the secondary credit inquiry message that invalidates the PIN, so that the secondary credit inquiry message can be supported by financial institution accounting system 122. In step S7, payment processing support device 1 sends the secondary credit inquiry message that has been generated to financial institution accounting system 122 from accounting system I/F 13.

When financial institution accounting system 122 receives the secondary credit inquiry message that has been sent from payment processing support device 1, determinator 125 accesses deposit account database 124 and, based on the information of the card member who is attempting to carry out settlement stored in deposit account database 124, determinator 125 determines whether the balance in the deposit account is less than the transaction amount included in the secondary credit inquiry message. Determinator 125 performs this step in order to determine if the card member's deposit account contains a large enough balance to pay the transaction amount or if the deposit account will be overdrawn as a result of the transaction. Accounting system 122 generates a settlement permission reply message if settlement is possible, or a settlement rejection reply message if settlement is not possible, such as where the account balance is less than the transaction amount. Accounting system 122 sends the reply message to accounting system I/F 13 of payment processing support device 1.

In step S8, payment processing support device 1 uses differentiator 16, for example, to determine whether the reply message that has been received by accounting system I/F 13 is a settlement rejection reply message. If payment processing support device 1 determines that the reply message that has been received is a rejection reply message, processing proceeds to step S4, for credit card 110 processing. If payment processing support device 1 determines that a settlement permission reply message has been received, it carries out debit card processing. That is, using message converter/generator 15, payment processing support device 1 converts the settlement permission reply message, which complies with the secondary standard to a reply message that complies with the primary standard. In step S9, converter/generator 15 sends the settlement permission reply message that complies with the primary standard to POS terminal 111 to notify the affiliated store and the card member, via POS terminal 111, that settlement has been completed.

That is, when signature debit card 130 is used at POS terminal 111, payment processing support device 1 usually processes it as a debit card. However, if the transaction amount exceeds the amount in the card member's deposit account, settlement cannot be carried out, and instead, credit card 110 processing is carried out.

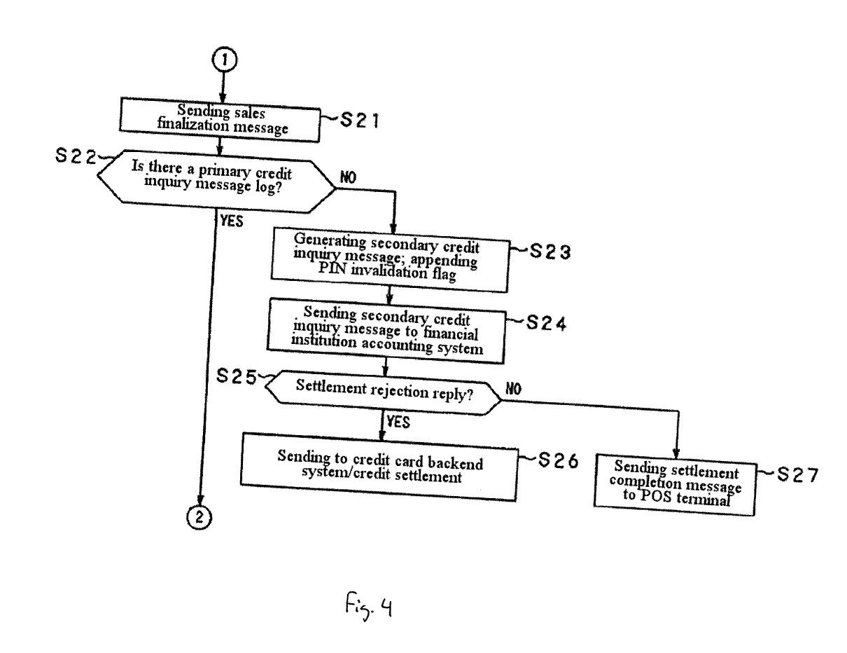

Sales finalization processing for credit card 110 is usually carried out after the credit inquiry. Therefore, when processing signature debit card 130, payment processing support device 1 determines, in step S10, whether sales finalization processing that follows a credit inquiry from a credit card 110 affiliated store has been carried out. That is, in step S10, payment processing support device 1 determines whether a sales finalization message has been received within a predetermined period in response to the previously received primary credit inquiry message. This step must be performed because there is a possibility that processing has not included sales finalization, or that a transaction has been canceled. The predetermined period may be, for example, as mentioned above, 30-40 days, and is counted by timer 19, with reference to the date and time of receipt of the relevant primary credit inquiry message that is stored in log storage part 17. If a sales finalization message has not been received within the predetermined period, in step S11, a cancellation message, canceling debit settlement processing that has already been carried out by accounting system 122, is generated by converter/generator 15 in the secondary standard. The cancellation message is sent from accounting system I/F 13 to accounting system 122. When accounting system 122 receives this cancellation message, it refunds the transaction amount that had been settled in accordance with a secondary credit inquiry message to the deposit account of the card member. However, if payment processing support device 1 receives a sales finalization message within the predetermined period, the process proceeds to step S21 as shown in FIG. 4.

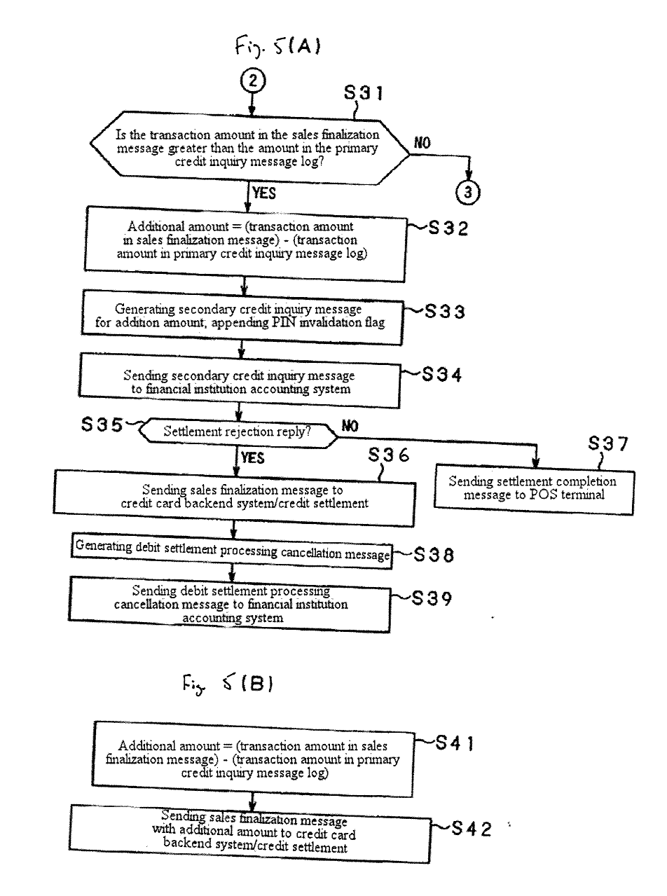

If payment processing support device 1 receives a sales finalization message via POS terminal I/F 11 in step S21, next, in step S22, comparing part 18 determines whether there is a primary credit inquiry message log in log storage part 17 that corresponds to a sales finalization message. This step is performed because there are cases, i.e., transactions involving amounts below the floor limit, in which credit inquiries are not made. If there is a log available, the process proceeds next to step S31 as illustrated in FIG. 5. If there is no log available, payment processing support device 1 uses message converter/generator 15 to generate a secondary credit inquiry message in step S23, based on the sales finalization message that has been received. At this time, a flag that invalidates the PIN is appended to the generated secondary credit inquiry message, so that it can be supported by financial institution accounting system 122. In step S24, payment processing support device 1 sends the secondary credit inquiry message that has been generated to financial institution accounting system 122 from accounting system I/F 13.

When financial institution accounting system 122 receives the secondary credit inquiry message that has been sent from payment processing support device 1, it accesses deposit account database 124, based on the information of the card member who is attempting to carry out settlement, and determinator 125 determines whether the balance in the deposit account is less than the transaction amount included in the secondary credit inquiry message. This step is performed in order to determine whether the transaction amount will exceed the deposit account balance, thus resulting in the account's being overdrawn. In response to accounting system I/F 13 of payment processing support device 1, accounting system 122 generates a settlement permission or settlement rejection reply message, and sends the reply message to accounting system I/F 13 of payment processing support device 1.

In step S25, payment processing support device 1 uses differentiator 16, for example, to determine whether the reply message that has been received by accounting system I/F 13 is a settlement rejection reply message. If payment processing support device 1 determines that the reply message that has been received is a rejection reply message, it proceeds to step S26, for credit card 110 processing. If payment processing support device 1 determines that a settlement permission reply message has been received, it carries out debit card processing. That is, using message converter/generator 15, payment processing support device 1 converts the settlement permission reply message, which complies with the secondary standard, to a reply message that complies with the primary standard. In step S27, converter/generator 15 sends the settlement permission reply message that complies with the primary standard to POS terminal 111 to notify the affiliated store and the card member, via POS terminal 111, that settlement has been completed.

If it is determined in step S22 in FIG. 4 that a log corresponding to a primary credit inquiry message is available in log storage part 17, the processing proceeds to step S31, as illustrated in FIG. 5A. That is, in step S31, payment processing support device 1, using comparing part 18, determines whether the transaction amount included in a sales finalization message that has been received by the POS terminal I/F 11 is greater than the transaction amount in the primary credit inquiry message log corresponding to the sales finalization message.

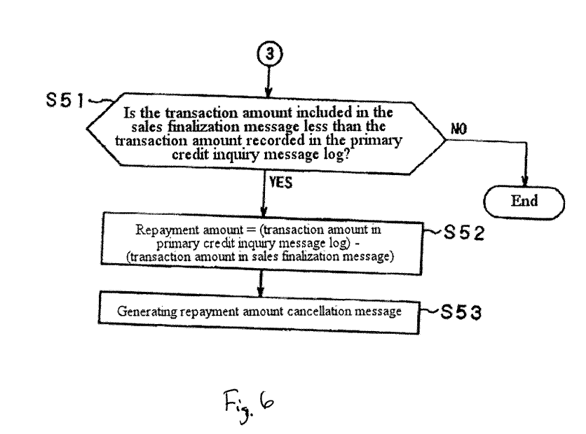

If the transaction amount included in the sales finalization message is greater, the process proceeds to step S32. This occurs when additional charges, such as shipping charges, taxes, and the like have been added to the price after the credit inquiry was carried out. However, if the transaction amount included in the sales finalization message is smaller, the process proceeds to step S51 in FIG. 6.

If the transaction amount included in the sales finalization message is greater than the transaction amount in the primary credit inquiry message log corresponding to the sales finalization message, payment processing support device 1, in step S32, using comparing part 18, computes the difference between the transaction amount included in the sales finalization message and the transaction amount in the primary credit inquiry message log corresponding to the sales finalization message. The difference is called the “additional amount.” Comparing part 18 computes the additional amount as follows: Additional amount=(transaction amount in sales finalization message)−(transaction amount in primary credit inquiry message log).

In step S33, payment processing support device 1, using message converter/generator 15, generates a secondary credit inquiry message complying with the secondary standard that includes the additional amount computed by comparing part 18. At this time, a flag that invalidates the PIN is appended to the secondary credit inquiry message generated, so that the secondary credit inquiry message is supported by financial institution accounting system 122. In step S34, payment processing support device 1 sends the secondary credit inquiry message that has been generated to financial institution accounting system 122 from accounting system I/F 13.

When financial institution accounting system 122 receives the secondary credit inquiry message that has been sent from payment processing support device 1, determinator 125 determines from deposit account database 124 whether the balance in the card member's deposit account is less than the additional amount included in the secondary credit inquiry message. In response to accounting system I/F 13 of payment processing support device 1, accounting system 122 generates a settlement permission or settlement rejection reply message, and sends the reply message to accounting system I/F 13 of payment processing support device 1.

In step S35, payment processing support device 1 determines whether the reply message that has been received by accounting system I/F 13 is a settlement rejection reply message. If payment processing support device 1 determines that the reply message that has been received is a rejection reply message, the process proceeds to step S36 for credit card 110 processing. If payment processing support device 1 determines that a settlement permission reply message has been received, it converts the settlement permission reply message that complies with the secondary standard to a reply message that complies with the primary standard. In step S37, the converter/generator 15 sends the settlement permission reply message that complies with the primary standard to POS terminal 111 to notify the affiliated store and the card member, via POS terminal 111, that settlement has been completed.

If credit card 110 processing is carried out in step S36, payment processing support device 1 sends the sales finalization message received by backend system I/F 12 in step S21 to credit card 110 backend system 112. That is, it is possible at this point to carry out credit settlement of the entire transaction amount included in the sales finalization message. Hence, it is necessary to cancel debit settlements that have already been carried out, in order to prevent double payment by the card member. In step S38, therefore, payment processing support device 1 uses message converter/generator 15 to generate a cancellation message, canceling debit settlement processing that has been carried out based on the primary credit inquiry message. In step S39, this cancellation message is sent from accounting system I/F 13 to accounting system 122. Thereby, repayment processing is carried out, since debit settlements that have already been carried out are canceled by accounting system 122.

In an alternate embodiment depicted in FIG. 5B, if payment processing support device 1 receives a settlement rejection message in step S35, processing proceeds to step S41. In step S41, payment processing support device 1 uses comparing part 18 to reduce the transaction amount included in the sales finalization message to the additional amount (the difference between the transaction amount in sales finalization message and transaction amount in primary credit inquiry message log corresponding to the sales finalization message). This step may be omitted, since it is the same as the aforementioned step S32.

Next, in step S42, payment processing support device 1 sends a sales finalization message with the additional amount to credit card 110 backend system 112 from backend system I/F 12. That is, only the additional amount is subject to credit settlement herein. In this embodiment, payment processing support device 1 does not generate a debit settlement cancellation message. Thus, in summary, while the entire transaction amount in the sales finalization message is subject to credit settlement if debit settlement of the additional amount is impossible in steps S36, S38, and S39 of FIG. 5A, in FIG. 5(B), only the additional amount is subject to credit settlement.

Returning to step S31 of FIG. 5A, if comparing part 18 determines that the transaction amount included in the sales finalization message is not greater than the transaction amount included in the primary credit inquiry message log corresponding to the sales finalization message, processing proceeds to step S51 in FIG. 6. In step S51, payment processing support device 1 uses comparing part 18 to determine whether the transaction amount included in the sales finalization message is less than the transaction amount recorded in the primary credit inquiry message log corresponding to the sales finalization message. The transaction amount included in the sales finalization message may be less than the transaction amount recorded in the primary credit inquiry message log corresponding to the sales finalization message due to the use of a coupon after the credit inquiry.

If the transaction amount included in the sales finalization message is less than the transaction amount recorded in the primary credit inquiry message log corresponding to the sales finalization message, payment processing support device 1 uses comparing part 18, in step S52, to compute the amount by which the transaction amount in the primary credit inquiry message log corresponding to the sales finalization message is in excess of the transaction amount included in the sales finalization message. This amount is the repayment amount and is computed as follows: Repayment amount=(transaction amount in primary credit inquiry message log)−(transaction amount in sales finalization message).

In step S53, payment processing support device 1, using message converter/generator 15, generates a cancellation message that complies with the secondary standard, comprising the repayment amount computed by comparing part 18. Processing then proceeds to step S39, shown in FIG. 5A. In step S39, payment processing support device 1 sends the cancellation message that has been generated to financial institution accounting system 122 from accounting system I/F 13. Thereby, repayment processing is carried out, since debit settlements that have already been carried out are canceled by accounting system 122.

In step S51, if comparing part 18 determines that the transaction amount included in the sales finalization message is not less than the transaction amount recorded in the primary credit inquiry message log corresponding to the sales finalization message, the transaction amount recorded in the primary credit inquiry message log matches the transaction amount included in the sales finalization message, and debit settlement that has been carried out in accordance with a secondary credit inquiry message corresponding to the primary credit inquiry message (debit settlement carried out after step S7 in FIG. 3) remains valid.

As described above, when a signature debit card 130 is used at a POS terminal 111 and debit settlement cannot be carried out under circumstances in which a debit card would ordinarily be used, payment processing support device 1 carries out credit settlement. As a result of this credit settlement, the relevant financial institution does not have to bear the burden of overuse, thus reducing the burden on financial institutions. Meanwhile, credit settlement of the overuse amount is within the range of risk that is conventionally assumed by credit card companies in the course of transactions, and it is therefore possible to avoid any new burdening of credit card companies.

Because payment processing support device 1 carries out credit settlement when a special credit inquiry message, such as a 1-dollar authorization or an authorization reservation, is received, a financial institution may use the conventional accounting system 122 for the above-described credit settlement of the signature debit card 130 transaction. It may, however, be necessary to modify the conventional accounting system 122 to respond to credit inquiry messages. It would be unnecessary for a credit company to modify the backend system 112. Thus, payment processing support device 1 makes it possible to eliminate the burden of overuse for financial institutions while requiring minimal modification to the designs of credit card 110 backend system 112 and financial institution accounting system 122. Payment processing support device 1 is therefore capable of providing an environment wherein financial institutions may readily implement signature debit card 130, and may thus contribute to the dissemination of signature debit card 130.

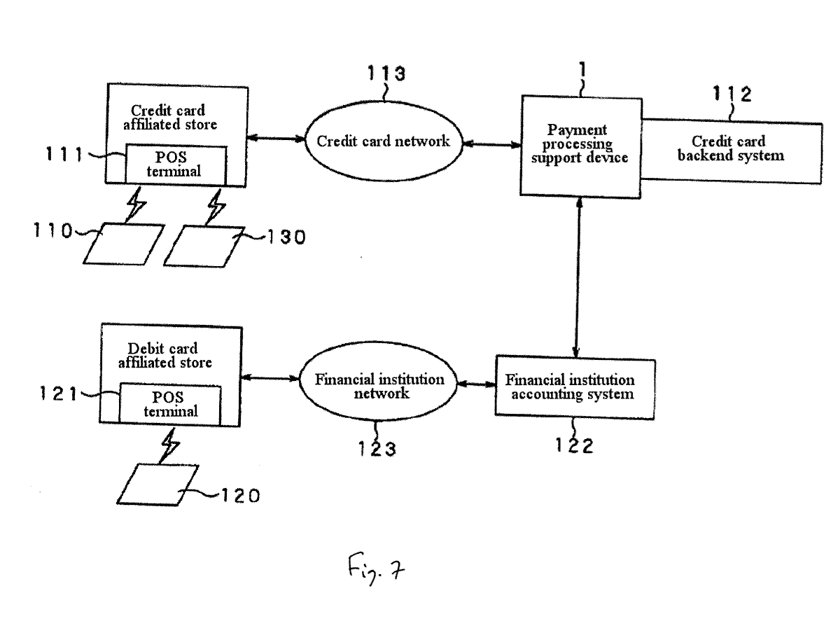

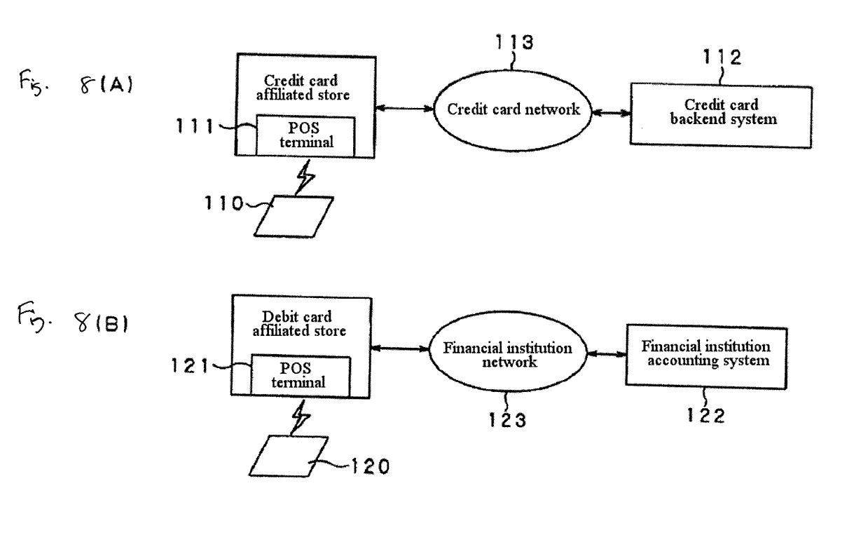

FIG. 7 is a schematic diagram of an alternate exemplary embodiment of the credit and debit card system with payment processing support device according to the present invention. As shown in FIG. 7, payment processing support device 1 may also be installed as a front end processor (FEP) for credit card 110 backend system 112. One skilled in the art would find this embodiment to be advantageous because it reduces the number of communications lines and improves line efficiency. In addition, any card abuse detection system that is installed in backend system 112 may also be used for payment processing support device 1.

The foregoing merely illustrates the principles of the invention. Various modifications and alterations to the described embodiments will be apparent to those skilled in the art in view of the teachings herein. It will thus be appreciated that those skilled in the art will be able to devise numerous techniques which, although not explicitly described herein, embody the principles of the invention and are thus within the spirit and scope of the invention.

I claim:

1. A method for processing transactions using a signature debit card comprising:
receiving a transaction information message in a primary message format comprising an information message transaction amount and signature debit card identification information from a point of sale terminal;
generating a message in a secondary message format from at least said information message transaction amount and said identification information;
transmitting said message in a secondary message format to a debit processing system that maintains an account associated with said signature debit card identification information;
receiving a response message from said debit processing system, indicating whether said information message transaction amount is allowed based at least in part on an account balance of said account associated with said signature debit card identification information; and
transmitting a credit settlement message to a credit card backend system to perform credit settlement of said transaction when said response message indicates that said information message transaction amount is not allowed.

2. The method of claim 1, wherein said primary message format is a credit card authorization request.

3. The method of claim 2, wherein said secondary message format is a debit card transaction request.

4. The method of claim 3, wherein said message in a secondary message format includes a flag to prevent PIN validation by said debit processing system.

5. The method of claim 2, wherein said response message is formatted as a debit card transaction response message.

6. The method of claim 1, wherein said transaction information message is one of a settlement message or a clearing message.

7. The method of claim 6, further comprising determining whether said transaction information message is related to a previously received transaction authorization request message pertaining to the same transaction, and, if the result of said determining is in the affirmative, comparing said information message transaction amount with a previously received transaction amount associated with said previously received transaction authorization request message.

8. The method of claim 7, further comprising generating an additional amount message if said information message transaction amount is greater than said previously received transaction amount associated with said previously received transaction authorization request message, wherein said additional amount message includes a transaction amount equal to the amount said information message transaction amount exceeds said previously received transaction amount associated with said previously received transaction authorization request message

9. The method of claim 7, further comprising generating a refund amount message if said information message transaction amount is less than said previously received transaction amount associated with said previously received transaction authorization request message, wherein said refund amount message includes a transaction amount equal to the amount said previously received transaction amount associated with said previously received transaction authorization request message exceeds said information message transaction amount.

10. A method for processing transactions using a signature debit card comprising:
receiving an authorization request message in a credit card message format comprising an authorization amount associated with a transaction, and signature debit card identification information generated by a point of sale terminal;
generating a first debit card message in a debit card transaction format from at least said authorization amount and said debit card identification information, said first debit card message further including a flag to prevent PIN validation;
transmitting said first debit card message to a debit processing system that maintains an account associated with said signature debit card identification information;
receiving a debit response message from said debit processing system, indicating successful debiting of said authorization amount from said account associated with said signature debit card identification information;
storing a record of said debit response message in a storage area;
generating an authorization response message in a credit card message format from at least part of the data contained in said debit response message; and
transmitting said authorization response message to said point of sale terminal.

11. The method of claim 10, further comprising:
determining whether a predetermined period of time has elapsed following the receipt of said authorization request message without receiving a sales finalization message associated with said transaction;
generating a debit reversal message including a reversal amount equal to said authorization amount if the result of said determining is in the affirmative; and
transmitting said debit reversal message to said debit processing system.

12. The method of claim 10, further comprising:
receiving a sales finalization message associated with said transaction subsequent to said receiving an authorization request message, said sales finalization message containing a transaction settlement amount;
calculating an excess authorization amount equal to an amount said authorization amount exceeds said transaction settlement amount;
generating a refund debit card message, said refund debit card message containing a refund amount equal to said excess authorization amount;
transmitting said refund debit card message to said debit processing system, whereby said debit processing system is instructed to credit said account associated with said signature debit card identification information an amount equal to said excess authorization amount.

13. The method of claim 10, further comprising:
receiving a sales finalization message associated with said transaction subsequent to said receiving an authorization request message, said sales finalization message containing a transaction settlement amount;
calculating an excess settlement amount equal to an amount said transaction settlement amount exceeds said authorization amount;
generating a second debit card message in said debit card transaction format containing at least said excess settlement amount;
transmitting said second debit card message to said debit processing system; and
receiving an excess settlement debit response message from said debit processing system, indicating whether said excess settlement amount is allowed based, at least in part, on an account balance of said account associated with said signature debit card.

14. The method of claim 13, further comprising:
performing credit settlement of said excess settlement amount if the excess settlement debit response message indicates that the excess settlement amount is not allowed.

15. The method of claim 13, further comprising:
determining if the excess settlement debit response message indicates that the excess settlement amount is not allowed; and
if the result of said determining is in the affirmative, performing the additional steps of:
generating a debit reversal message, said reversal message including a reversal amount equal to said authorization amount;
transmitting said debit reversal message to said debit processing system;
generating a credit settlement message having a settlement amount equal to said transaction settlement amount; and
transmitting said credit settlement message to a credit card backend system that maintains a credit account associated with said signature debit card identification information.

16. An apparatus for processing a signature debit card transaction for a signature debit card comprising:
a merchant message receiver configured to receive at least one transaction information message in a primary message format comprising an information message transaction amount and signature debit card identification information;
a message converter configured to convert said at least one transaction information message from said merchant information receiver into a message in a secondary message format;
a transmitter configured to transmit said message in a secondary message format from said message converter to a debit processing system that maintains an account associated with said signature debit card;
a response message receiver configured to receive a response message from said debit processing system including an indication of whether said information message transaction amount is allowed based at least in part on an account balance of said account associated with said signature debit card; and
a credit card message transmitter configured to transmit a credit settlement message to a credit card backend system to perform credit settlement of said signature debit card transaction when said response message contains an indication that said information message transaction amount is not allowed.

17. The apparatus of claim 16, wherein said message converter is configured to convert a credit card authorization request message into a debit card transaction request message.

18. The apparatus of claim 16, wherein said message converter is configured to insert a flag to prevent PIN validation by said debit processing system into said message in a secondary message format.

19. The apparatus of claim 16, further comprising a storage device configured to store a log containing past message information regarding a plurality of old transaction information messages previously received by said merchant message receiver, said past message information including old information message transaction amount data associated with at least one of said plurality of old transaction information messages.

20. The apparatus of claim 19, further comprising a comparator configured to compare said transaction information message in a primary message format with said plurality of old transaction information messages stored in said log and to generate a match signal when it is determined that said transaction information message pertains to the same transaction as one of said plurality of old transaction information messages.

21. The apparatus of claim 20, further comprising a message generator configured to generate an additional amount message if said match signal is generated, said additional amount message including a transaction amount equal to the amount said information message transaction amount exceeds said old information message transaction amount data for said at least one of said plurality of old transaction information messages associated with said transaction.

22. The apparatus of claim 20, further comprising a message generator configured to generate a refund amount message if said match signal is generated, said refund amount message including a transaction amount equal to the amount said old information message transaction amount data for said at least one of said plurality of old transaction information messages associated with said transaction exceeds said information message transaction amount.

23. An apparatus for processing a signature debit card transaction for a signature debit card comprising:
a merchant authorization message receiver configured to receive an authorization request message in a credit card message format, said authorization request message including at least an authorization amount associated with said transaction and signature debit card identification information obtained at a point of sale device;
at least one debit card message generator configured to generate a first debit card message in a debit card transaction format, said first debit card message including at least said authorization amount, said signature debit card identification information, and a flag to prevent PIN validation;
a debit card message transmitter configured to transmit said first debit card message to a debit processing system that maintains a debit account associated with said signature debit card identification information;
a debit response message receiver configured to receive a debit response message from said debit processing system, indicating successful debiting of said authorization amount from said debit account;
a storage device configured to store a plurality of authorization records, each authorization record associated with one said authorization request message, including an associated transaction authorization amount;
a merchant authorization response message generator configured to generate an authorization response message in a credit card message format using at least part of the data contained in said debit response message; and
a merchant authorization response message transmitter configured to transmit said authorization response message to said point of sale device.

24. The apparatus of claim 23, further comprising:
a timing device comprising at least one of a clock, or a timer;
a comparator, connected to said timing device, to determine whether a predetermined period of time has elapsed following the receipt of said authorization request message without receiving a sales finalization message associated with the transaction, wherein said at least one debit card message generator is further configured to generate a debit reversal message having a reversal amount equal to said authorization amount if the result of said determining is in the affirmative.

25. The apparatus of claim 23, further comprising:
a sales finalization message receiver configured to receive a sales finalization message associated with said transaction subsequent to the receipt of said authorization request message, said sales finalization message containing a transaction settlement amount;
a processor, coupled to said sales finalization message receiver and said storage device, configured to calculate an excess authorization amount equal to the amount said authorization amount associated with said transaction exceeds said transaction settlement amount;
wherein said at least one debit card message generator is further configured to generate a refund debit card message, said refund debit card message containing a refund amount equal to said excess authorization amount;
and wherein said debit card message transmitter is further configured to transmit said refund debit card message to said debit processing system, whereby said debit processing system is instructed to credit said debit account associated with said signature debit card identification information an amount equal to said excess authorization amount.

26. The apparatus of claim 23, further comprising:
a sales finalization message receiver configured to receive a sales finalization message associated with said transaction subsequent to the receipt of said authorization request message, said sales finalization message containing a transaction settlement amount;
a processor, coupled to said sales finalization message receiver and said storage device, configured to calculate an excess settlement amount equal to the amount said transaction settlement amount exceeds said authorization amount associated with said transaction;
wherein said at least one debit card message generator is further configured to generate a second debit card message, said second debit card message containing an additional transaction amount equal to said excess settlement amount;
wherein said debit card message transmitter is further configured to transmit said second debit card message to said debit processing system; and
wherein said debit response message receiver is further configured to receive an excess settlement debit response message from said debit processing system, indicating whether said excess settlement amount is allowed based, at least in part, on an account balance of said debit account associated with said signature debit card identification information.

27. The apparatus of claim 26, further comprising:
a credit card message generator configured to generate a credit card settlement message if the excess settlement debit response message indicates that the excess settlement amount is not allowed.

28. The apparatus of claim 27, wherein said credit card settlement message includes a settlement amount equal to said excess settlement amount.

29. The apparatus of claim 27, wherein said at least one debit card message generator is further configured to generate a debit reversal message having a reversal amount equal to said authorization amount; wherein said credit settlement message includes a settlement amount equal to said transaction settlement amount; said apparatus further comprising a credit card message transmitter configured to transmit said credit card settlement message to a credit card backend system maintaining a credit account associated with said signature debit card identification information.
